(19) United States
(12) Patent Application Publication
(10) Pub. No.: US 2021/0195665 A1
(43) Pub. Date: Jun. 24, 2021

(54) METHOD FOR DISPLAYING SERVICE IDENTIFIER, ELECTRONIC DEVICE AND NON-TRANSITORY COMPUTER-READABLE STORAGE MEDIUM

(71) Applicant: GUANDGDONG OPPO MOBILE TELECOMMUNICATIONS CORP., LTD., Dongguan (CN)

(72) Inventors: Kai TANG, Dongguan (CN); Yang XIA, Dongguan (CN); Tao ZHANG, Dongguan (CN)

(21) Appl. No.: 17/193,134

(22) Filed: Mar. 5, 2021

Related U.S. Application Data
(63) Continuation of application No. PCT/CN2019/102883, filed on Aug. 27, 2019.

(30) Foreign Application Priority Data
Sep. 4, 2018 (CN) 201811027733.9

(51) Int. Cl. H04W 76/11; H04B 17/327; H04W 72/04; H04W 48/16; H04W 76/15

(52) U.S. Cl. CPC H04W 76/11; H04B 17/327; H04W 76/15; H04W 48/16; H04W 72/0413

(57) ABSTRACT

Disclosed in the embodiments of the present disclosure are a method for displaying a service identifier, being applied to an electronic device, the electronic device supporting an eMBB service and a doubly connected mode. The method includes: when it is detected that an electronic device activates the eMBB service, acquiring a new radio (NR) reference signal receiving power (RSRP) and an uplink transmission bandwidth threshold; determining the service identifier of the eMBB service according to the NR RSPR and the uplink transmission bandwidth threshold; and displaying the service identifier of the eMBB. Embodiments of the present disclosure further provide an electronic device and a non-transitory computer-readable storage medium.

### CROSS-REFERENCE TO RELATED APPLICATIONS

This application is a continuation of International Application No. PCT/CN2019/102883, filed on Aug. 27, 2019, which claims priority to Chinese Patent Application No. 201811027733.9, filed on Sep. 4, 2018, the entire disclosures of which are incorporated herein by reference.

### TECHNICAL FIELD

This disclosure relates to the technical field of electronic devices, and in particular to a method for displaying a service identifier, an electronic device and a non-transitory computer-readable storage medium.

### BACKGROUND

With the development of mobile communication technology, users have an increasing demand for communication with electronic devices such as mobile phones. When the electronic devices currently on the market transmit data, data services may be provided through a data network such as the 4th Generation (4G) Long Term Evolution (LTE) network, whereas telephone services may still need to be provided through a common circuit switching domain network such as the 2th Generation (2G) network or the 3th Generation (3G) network. The electronic device may display a service identifier on a relevant interface on the local end, to indicate the current communication status of the electronic device.

### BRIEF DESCRIPTION OF THE DRAWINGS

In order to more clearly illustrate technical solutions in the embodiments of the present disclosure or the related art, drawings needed for the description of the embodiments or the related art will be briefly introduced hereafter. Obviously, the drawings in the following description show only some embodiments of the present disclosure. For those of ordinary skill in the art, other drawings can be obtained based on these drawings without any creative work.

FIG. 1a is a diagram illustrating an exemplary architecture of a wireless communication system according to the embodiments of the present disclosure;

FIG. 1b is a schematic diagram illustrating connection of the communication system according to the embodiments of the present disclosure;

FIG. 2 is a schematic flowchart of a method for displaying a service identifier according to the embodiments of the present disclosure;

FIG. 3 is a schematic flowchart of another method for displaying a service identifier according to the embodiments of the present disclosure;

FIG. 4 is a schematic flowchart of another method for displaying a service identifier according to the embodiments of the present disclosure;

FIG. 5 is a schematic structural diagram of an electronic device according to the embodiments of the present disclosure; and

FIG. 6 is a block diagram illustrating functional units of an apparatus for displaying a service identifier according to the embodiments of the present disclosure.

### DETAILED DESCRIPTION OF PREFERRED EMBODIMENTS

In order to enable those skilled in the art to better understand the solutions of the disclosure, the technical solutions in the embodiments of the disclosure will be clearly and completely described below in conjunction with the drawings in the embodiments of the disclosure. Obviously, the described embodiments are only a part, rather than all, of the embodiments of this disclosure. Based on the embodiments in this disclosure, all other embodiments, obtained by those of ordinary skill in the art without any creative work, shall fall within the protection scope of this disclosure.

The terms “first”, “second” and the like in the description, claims and the drawings of the disclosure are used to distinguish different objects, rather than describing a specific sequence. In addition, the terms “comprise” and “have” as well as any variations thereof are not intended to exclude other items not mentioned. For example, a process, method, system, product or device that includes a series of operations or units is not limited to the listed operations or units, but may also include unlisted operations or units, or may optionally include other operations or units inherent to such process, method, product or device.

Reference to “an embodiment” herein means that a specific feature, structure, or characteristic described in conjunction with this embodiment may be included in at least one embodiment of the present disclosure. The appearance of the phrase in various places of the description does not necessarily refer to a same embodiment, nor is it an independent or alternative embodiment mutually exclusive with other embodiments. Those skilled in the art may clearly and implicitly understand that the embodiments described herein can be combined with other embodiments.

The electronic device involved in the embodiments of the present disclosure may be an electronic device with a data transmission capability. Such an electronic device may include: various handheld devices, on-board equipment, wearable devices and computing devices with a wireless communication function, or other processing devices connected to wireless modems; and various user equipment (UE), Mobile Stations (MS), terminal devices, and so on. The embodiments of the disclosure will be described in detail below.

Regarding the service identifier of the 5th Generation (5G) system, there is currently no solution for displaying the service identifier of an enhanced Mobile Broadband (eMBB) service in the 5G Non-Standalone (NSA) communication system.

The embodiments of the disclosure provide a method for displaying a service identifier, which is applicable to an electronic device. The electronic device supports an enhanced Mobile Broadband (eMBB) service and a doubly connected mode. In the doubly connected mode, the electronic device establishes a first communication connection with a first network device and establishes a second communication connection with a second network device. The first and second network devices are on a first 5th Generation (5G) Non-Standalone (NSA) network. The first network device is an evolutional 4th Generation (4G) nodeB (eNB). The second network device is a 5G nodeB (gNB). A core of the first 5G NSA network is a 5G Next Generation (NG) core. The first network device communicates with the second network device and the 5G NG core. The method may include: acquiring a New Radio (NR) Reference Signal Receiving Power (RSRP) and an uplink transmission bandwidth threshold, when it is detected that the electronic device activates the eMBB service; determining a service identifier of the eMBB service according to the NR RSPR and the uplink transmission bandwidth threshold; and displaying the service identifier of the eMBB service.

In an optional implementation of the method for displaying a service identifier, the determining the service identifier of the eMBB service according to the NR RSPR and the uplink transmission bandwidth threshold includes:

determining a 5G identifier of the eMBB service as the service identifier of the eMBB service, when the NR RSPR is greater than a power threshold and the uplink transmission bandwidth threshold is greater than an uplink threshold; or

acquiring a 4G ratio LTE_ratio and a 5G ratio NR_ratio in an uplink data distribution when the NR RSPR is smaller than the power threshold and the uplink transmission bandwidth threshold is smaller than the uplink threshold, and determining a 4G identifier of the eMBB service as the service identifier of the eMBB service when the LTE_ratio is greater than the NR_ratio, or determining a 5G identifier of the eMBB service as the service identifier of the eMBB service when the LTE_ratio is smaller than or equal to the NR_ratio.

In an optional implementation of the method for displaying a service identifier, the LTE_ratio is calculated as follows: LTE_ratio=(10 GB−A)/10 GB, where A is an upstream transmission bandwidth pre-assigned to the first network device; and the NR_ratio is obtained by subtracting the LTE_ratio from the uplink transmission bandwidth threshold.

In an optional implementation of the method for displaying a service identifier, the 5G identifier of the eMBB service is 5G eMBB, and the 4G identifier of the eMBB service is 4G.

In an optional implementation of the method for displaying a service identifier, after it is detected that the electronic device activates the eMBB service, the method may further include:

sending, to the first network device, a service identifier query request for querying the service identifier of the eMBB service; and

receiving service identifier indication information from the first network device, the service identifier indication information including the NR RSRP and the uplink transmission bandwidth threshold.

In an optional implementation of the method for displaying a service identifier, the displaying the service identification of the eMBB service may include:

displaying the service identifier at a preset position of an interface for the eMBB service of the electronic device, the preset position matching a display position of the electronic device where a network connection status is displayed.

In an optional implementation of the method for displaying a service identifier, the method may further include: transmitting data of the eMBB service through the first 5G NSA network.

In an optional implementation of the method for displaying a service identifier, the transmitting the data of the eMBB service through the first 5G NSA network may include: transmitting the data of the eMBB service through the second communication connection and the 5G NG core.

In an optional implementation of the method for displaying a service identifier, the transmitting the data of the eMBB service through the first 5G NSA network may include: transmitting the data of the eMBB service through the second and first communication connections and the 5G NG core.

The embodiments of the present disclosure provide an apparatus for displaying a service identifier, which is applicable to an electronic device. The electronic device supports an eMBB service and a doubly connected mode. In the doubly connected mode, the electronic device establishes a first communication connection with a first network device and establishes a second communication connection with a second network device. The first and second network devices are on a first 5G NSA network. The first network device is an evolutional 4G nodeB (eNB). The second network device is a 5G nodeB (gNB). A core of the first 5G NSA network is a 5G NG core. The first network device communicates with the second network device and the 5G NG core. The apparatus may include a processing unit and a communication unit. The processing unit is configured to acquire a NR RSRP and an uplink transmission bandwidth threshold when it is detected that the electronic device activates the eMBB service, determine a service identifier of the eMBB service according to the NR RSPR and the uplink transmission bandwidth threshold; and display the service identifier of the eMBB service.

In an optional implementation of the apparatus for displaying a service identifier, the processing unit is specifically configured to: determine a 5G identifier of the eMBB service as the service identifier of the eMBB service, when the NR RSPR is greater than a power threshold and the uplink transmission bandwidth threshold is greater than an uplink threshold; or acquire a 4G ratio LTE_ratio and a 5G ratio NR_ratio in an uplink data distribution when the NR RSPR is smaller than the power threshold and the uplink transmission bandwidth threshold is smaller than the uplink threshold, and determine a 4G identifier of the eMBB service as the service identifier of the eMBB service when the LTE_ratio is greater than the NR_ratio, or determine a 5G identifier of the eMBB service as the service identifier of the eMBB service when the LTE_ratio is smaller than or equal to the NR_ratio.

In an optional implementation of the apparatus for displaying a service identifier, the LTE_ratio is calculated as follows: LTE_ratio=(10 GB-A)/10 GB, where A is an upstream transmission bandwidth pre-assigned to the first network device, and the NR_ratio is obtained by subtracting the LTE_ratio from the uplink transmission bandwidth threshold.

In an optional implementation of the apparatus for displaying a service identifier, the 5G identifier of the eMBB service is 5G eMBB, and the 4G identifier of the eMBB service is 4G.

In an optional implementation of the apparatus for displaying a service identifier, the communication unit is configured to send, to the first network device, a service identifier query request for querying the service identifier of the eMBB service; and receive service identifier indication information from the first network device. The processing unit is further configured to determine the service identifier of the eMBB service according to the service identifier indication information, and store the determined service identifier of the eMBB service.

In an optional implementation of the apparatus for displaying a service identifier, the processing unit is specifically configured to display the service identifier at a preset position of an interface for the eMBB service of the electronic device, the preset position matching a display position of the electronic device where a network connection status is displayed.

In an optional implementation of the apparatus for displaying a service identifier, the communication unit is further configured to transmit data of the eMBB service data through the first 5G NSA network.

In an optional implementation of the apparatus for displaying a service identifier, the communication unit is specifically configured to transmit the data of the eMBB service through the second communication connection and the 5G NG core.

The technical solutions of the embodiments of the present disclosure can be applied to various communication systems, including but not limited to: Global System of Mobile Communication (GSM) system, Code Division Multiple Access (CDMA) system, Wideband Code Division Multiple Access (WCDMA) system, General Packet Radio Service (GPRS) system, Long Term Evolution (LTE) system, LTE Frequency Division Duplex (FDD) system, LTE Time Division Duplex (TDD) system, Universal Mobile Telecommunication System (UMTS), Worldwide Interoperability for Microwave Access (WiMAX) communication system, 5G New Radio (NR), and the like. In particular, the technical solutions of the embodiments of the present disclosure may be applied to the eMBB service under the Option 7a architecture.

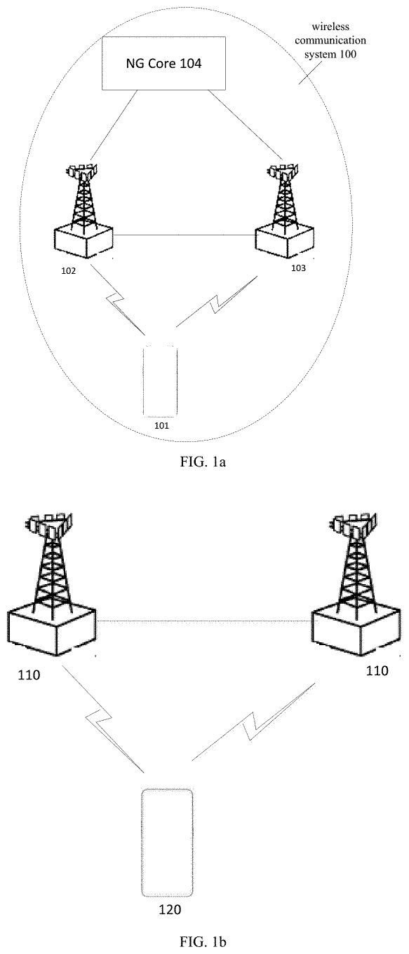

As shown in FIG. 1a, a wireless communication system 100 according to the embodiments of the present disclosure may include: an electronic device, nodeBs, and a 5G Next Generation (NG) core. The network, which the electronic device 101 accesses, is a 5G NSA network. This network may include a nodeB 102 (a 4G nodeB, eNB), a nodeB 103 (a 5G nodeB, gNB), and a Next generation (NG) Core 104. Control signaling may be transmitted through the nodeB 102, and user data of the electronic device may be transmitted to the NG Core 104 respectively through the nodeB 102 and nodeB 103. The nodeB 103 communicates with the NG Core 104. The electronic device 101 may simultaneously communicate with the nodeB 102 and the nodeB 103 in the doubly connected mode, and may implement data services such as eMBB services through this network.

The communication system to which the embodiments of the present disclosure are applied is exemplarily illustrated in FIG. 1b. The communication system may include network devices 110. The network devices 110 may communicate with a terminal device 120 (or referred to as a communication terminal device or a terminal device). The network devices 110 may provide communication covering a specific geographic area, and may communicate with terminal devices within the covered area. As shown in FIG. 1b, the terminal device supports dual connectivity, that is, the terminal device 120 may be connected to two network devices, where one of the network devices 110 (as shown on the left side of FIG. 1b) may be an evolutional NodeB (eNB or eNodeB) in the LTE system, and the other one of the network devices (as shown on the right side of FIG. 1b) may be a NodeB in the 5G network (gNB).

The communication system may also include at least one terminal device 120 located within the coverage area of the network devices 110. The “terminal device” used herein may be connected through multiple ways including but not limited to: wired connection, such as connections via Public Switched Telephone Networks (PSTN), via Digital Subscriber Lines (DSL) or via digital cables, and direct cable connections; and/or connections via another data connection/network; and/or connections via a wireless interface, for example connections via a cellular network, a Wireless Local Area Network (WLAN), a digital TV network such as DVB-H network, a satellite networks, or an AM-FM broadcast transmitter; and/or connections by means of another terminal device that is configured to receive/send communication signals; and/or connections via Internet of Things (IoT) equipment. The terminal device configured to communicate through a wireless interface may be referred to as a “wireless communication terminal device”, a “wireless terminal device” or a “mobile terminal device”. Examples of the mobile terminal device may include but are not limited to: satellite or cellular phones; Personal Communications System (PCS) terminal devices that integrate cellular radio phones with data processing, fax, and data communication capabilities; Personal Digital Assistants (PDAs) incorporating a radio phone, a pager, Internet/Intranet access, a Web browser, a notebook, calendar and/or a Global Positioning System (GPS) receiver; and common laptop and/or palmtop receiver or other electronic devices including a radio phone transceiver. The terminal device may refer to an access terminal device, user equipment (UE), a user unit, a user station, a mobile station, a mobile terminal, a remote station, a remote terminal device, a mobile device, a user terminal device, a terminal device, a wireless communication device, a user agent or a user device. The access terminal device may be a cellular phone, a cordless phone, a Session Initiation Protocol (SIP) phone, a Wireless Local Loop (WLL) station, a PDA, a handheld device with a wireless communication function, a computing device or other processing devices connected to wireless modems, on-board equipment, a wearable device, a terminal device in the 5G network, a terminal device in the future evolutional PLMN, or the like.

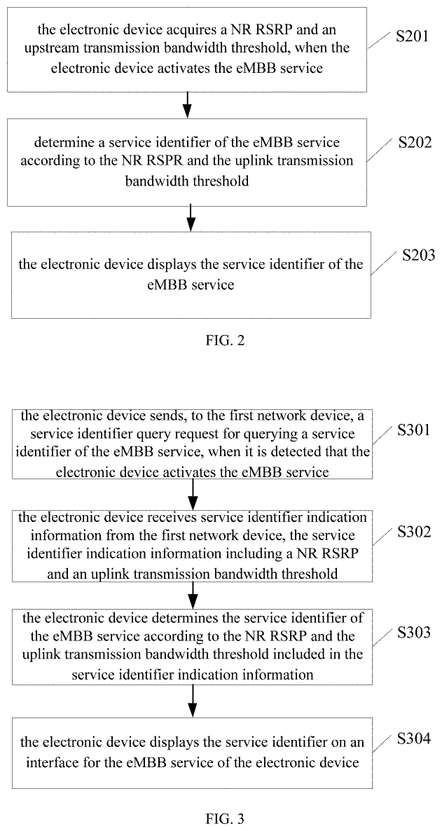

Referring to FIG. 2, a schematic flow diagram of a method for displaying a service identifier according to the embodiments of the present disclosure is illustrated, which method may be applied to the electronic device shown in FIG. 1a or FIG. 1b. The electronic device supports an eMBB service and a doubly connected mode. In the doubly connected mode, the electronic device establishes a first communication connection with a first network device and establishes a second communication connection with a second network device. The first and second network devices are on a first 5G NSA network. The first network device is an evolutional 4G nodeB (eNB), and the second network device is a 5G nodeB (gNB). A core of the first 5G NSA network is a packet 5G NG core. The first network device communicates with the second network device and the NG core. As shown in the figure, the method for displaying a service identifier may include operations as follows.

In operation S201, the electronic device acquires a NR Reference Signal Receiving Power (RSRP) and an upstream transmission bandwidth threshold, when the electronic device activates the eMBB service. In an implementation, the electronic device may acquire the NR RSPR and the uplink transmission bandwidth threshold by detecting on the local side, or may acquire such information from the NG core through the nodeB.

In operation S202, the electronic device determines a service identifier of the eMBB service according to the NR RSPR and the uplink transmission bandwidth threshold.

The service identifier indicates a transmission form of the service data of the eMBB service under different network architectures. For example, in a 4G LTE network, the electronic device displays a 4G identifier, such as 4G or LTE eMBB, on an interface for the eMBB service. For another example, in a 5G network, the electronic device displays a 5G identifier, such as 5G or 5G eMBB, on the interface for the eMBB service. The identifier is used to indicate the data distribution situation under the uplink data distribution scheme performed on the electronic device. For example, if a 4G identifier is displayed, it means that an uplink data distribution scheme is adopted in which a part of the data is transmitted to the NG core through the eNB and the other part of the data is transmitted to the NG core through the gNB, and an LTE_ratio (4G ratio) is greater than a NR_ratio (5G ratio). For another example, if 5G eMBB is displayed, it means that no uplink data distribution scheme is adopted, or an uplink data distribution scheme is adopted in which the LTE_ratio is smaller than the NR_ratio. The power threshold and the uplink threshold may be set in advance, which do not limit the embodiments of the disclosure.

The LTE_ratio may be calculated as follows: LTE_ratio=(10 GB-A)/10 GB, where A is an uplink transmission bandwidth pre-assigned to the LTE network. The NR_ratio may be obtained by subtracting the LTE_ratio from the uplink transmission bandwidth threshold, i.e., NR_ratio=the uplink transmission bandwidth threshold-LTE_ratio.

In operation S203, the electronic device displays the service identifier of the eMBB service.

In the embodiments of the present disclosure, when it is detected that the electronic device activates an eMBB service, the electronic device acquires a NR RSRP and an uplink transmission bandwidth threshold, determines a service identifier of the eMBB service according to the NR RSPR and the upstream transmission bandwidth threshold, and displays the service identifier on an interface. As can be seen, during the execution of the eMBB service, the electronic device can determine the corresponding service identifier according to the status of the uplink data, and display for example a 4G identifier or a 5G identifier. In this way, the actual data transmission status of the electronic device during the eMBB service can be accurately, intuitively and comprehensively displayed, which is beneficial to improve the comprehensiveness and accuracy of the information display of the electronic device under the eMBB service.

In a possible example, after the electronic device activates the eMBB service, the method may further include: sending, by the electronic device, to the first network device a service identifier query request for querying the service identifier of the eMBB service; and receiving service identifier indication information from the first network device.

In an implementation, the service identifier indication information includes the NR RSRP and the uplink transmission bandwidth threshold; and after receiving the service identifier indication information, the electronic device may determine the service identifier of the eMBB service according to the NR RSRP and the uplink transmission bandwidth threshold included in the service identifier indication information.

In this case, for example, after the electronic device activates the eMBB service, the electronic device sends the service identifier query request to the NG core through a control channel with the first network device, i.e., the eNB. That is, the electronic device sends to the first network device a service identifier query request for querying the service identifier of the eMBB service, and the first network device forwards the service identifier query request to the NG core. In response to the service identifier query request, the NG core generates service identifier indication information and sends it to the first network device, the service identifier indication information including the NR RSRP and the uplink transmission bandwidth threshold. The first network device returns the service identifier indication information to the electronic device, so that the electronic device may determine the service identifier of the eMBB service according to the service identifier indication information, in particular the NR RSRP and the uplink transmission bandwidth threshold.

The eMBB service is one of the important functions of the electronic device. After the electronic device accesses the first 5G NSA network, the type of the service identifier corresponding to the data service supported by the current network architecture may be determined by means of the service identifier query request, that is, an agreement on a service identifier query mechanism may be made at the protocol level. In addition, the service identifier information of the eMBB service under the network architecture may exist on the network side.

Alternatively, in an implementation, the electronic device may send the service identifier query request through a control channel (such as a Common Control Channel (CCCH) or a Dedicated Control Channel (DCCH)) with the nodeB. That is, the nodeB for example forwards the service identifier query request to the NG core. After receiving the service identifier query request from the electronic device, the NG core may generate service identifier indication information according to a service identifier of the eMBB service that is pre-configured locally, and send the generated service identifier indication information to the electronic device through the nodeB, the service identifier indication information indicating the service identifier of the eMBB service to be displayed. The electronic device may extract the service identifier of the eMBB service to be displayed from the service identifier indication information. Optionally, the electronic device may store the determined service identifier of the eMBB service.

The service identifier of the eMBB service may include a 4G identifier and a 5G identifier. The specific representations of the 4G and 5G identifiers may vary among different operators, which are not limited in this disclosure.

In this example, the electronic device can quickly and accurately determine the service identifier of the eMBB service by means of the query mechanism, improving the accuracy and efficiency of displaying the service identifier.

The electronic device may be preset in such a manner that it is enabled to access multiple different network architectures, such as a 4G LTE network, a 5G NSA network (including various sub-network architectures), and a 5G Standalone (SA) network. Resources (such as channels) configured for the electronic device to support the eMBB service may be different under different network architectures. At the level of operators, different operators may deploy mobile networks with different network architectures, and the assigned frequency domain resources are different. Based on this, the service identifier that needs to be displayed may be determined by detecting the difference between the channels currently enabled by the eMBB service.

In this example, since different service channels are enabled when different network architectures support the eMBB service, the electronic device may detect the currently enabled channels, and perform comparison and query based on the different characteristic parameters (such as the RSRP and the uplink transmission bandwidth threshold) of the channels, to obtain the service identifier to be displayed, thereby improving the accuracy and instantaneity of the electronic device in displaying the service identifier.

In a possible example, the displaying, by the electronic device, the service identifier on an interface for the eMBB service of the electronic device may include: displaying the service identifier at a preset position of an interface for the eMBB service of the electronic device, the preset position matching a display position of the electronic device where a network connection status is displayed.

The preset position matching a display position of the electronic device where a network connection status is displayed, may mean that the preset position may be adjacent to, opposite to, or separated by a preset distance (for example, 1 mm to 150 mm) from the display position where the network connection status is displayed, which is not uniquely defined here. In addition, the display parameters (such as color, background color, font, and size) of the service identifier may be consistent with those of the network connection state, or may also be inconsistent therewith, which is also not uniquely defined here. For example, the font size and the background color of the service identifier may be set to be the same as those of the network connection status.

In this example, the electronic device can display the service identifier at a preset position on an interface for the eMBB service, with the preset position matching the display position where the network connection status is displayed. As such, the current communication status of the electronic device can be completely presented, and the comprehensiveness of the electronic device in displaying the communication status information can be improved.

In a possible example, the displaying, by the electronic device, the service identifier on an interface for the eMBB service of the electronic device may include: switching, by the electronic device, from a network connection status identifier to the service identifier on the interface for the eMBB service of the electronic device.

In a possible example, the displaying, by the electronic device, the service identifier on an interface for the eMBB service of the electronic device may include: determining, by the electronic device, an interface for the eMBB service; querying a corresponding relationship between a pre-configured interface and a display position for the service identifier, to determine a corresponding target display position on the interface for the eMBB service; and displaying the service identifier at the target display position.

In an implementation, the preset position may be different positions on the electronic device for different types of interfaces. For example, for a data status interface, the service identifier may be displayed in the upper left corner of the interface; and for an integrated application interface that is presented in response to opening of an another application in the data status interface, the service identifier may be displayed for example in the upper-middle part of the integrated application interface.

In this example, for different types of interfaces for the eMBB service, the electronic device can flexibly adapt the display position of the service identifier on the current service interface, thereby improving the flexibility and intelligence of the electronic device in displaying the service identifier.

In a possible example, the method may further include: transmitting, by the electronic device, service data of the eMBB service through the first 5G NSA network.

The service data of the eMBB service may include the user's uplink data.

In this example, the electronic device can transmit the uplink data of the eMBB service through the first 5G NSA network, which is consistent with the network architecture associated with the currently displayed service identifier, thereby improving the consistency of the service identifier displayed by the electronic device.

The transmitting, by the electronic device, the uplink data of the eMBB service through the first 5G NSA network may include: transmitting the uplink data of the service through the second communication connection and the NG core (for the case where no uplink data distribution scheme is adopted); or transmitting the uplink data of the eMBB service through the second and first communication connections and the NG core (for the case where an uplink data distribution scheme is adopted).

In an implementation, the uplink data may be transmitted to the NG core directly through the second communication connection for interaction, or may be transmitted to the NG core directly through the first communication connection for interaction, according to the actual situation.

In this example, since the electronic device is in the doubly connected mode, the transmission of the service data can be flexibly selected based on the quality of the channels, thereby improving the efficiency and stability of the data transmission.

Referring to FIG. 3, a schematic flowchart of a method for displaying a service identifier according to the embodiments of the present disclosure is illustrated, which is consistent to the embodiment shown in FIG. 2. The method may be applied to the electronic device in the communication system shown in FIG. 1a. The electronic device supports an eMBB service and a doubly connected mode. In the doubly connected mode, the electronic device establishes a first communication connection with a first network device and establishes a second communication connection with a second network device. The first and second network devices are on a first 5th Generation (5G) Non-Standalone (NSA) network. The first network device is an evolutional 4G nodeB (eNB), and the second network device is a 5G nodeB (gNB). A core of the first 5G NSA network is a NG core. The first network device communicates with the second network device and the NG core. As shown in the figure, the method for displaying a service identifier may include operations as follows.

In operation S301, the electronic device sends, to the first network device, a service identifier query request for querying a service identifier of the eMBB service, when it is detected that the electronic device activates the eMBB service.

In operation S302, the electronic device receives service identifier indication information from the first network device, the service identifier indication information including a NR RSRP and an uplink transmission bandwidth threshold.

In operation S303, the electronic device determines the service identifier of the eMBB service according to the NR RSRP and the uplink transmission bandwidth threshold included in the service identifier indication information.

In operation S304, the electronic device displays the service identifier on an interface for the eMBB service of the electronic device.

In the embodiments of the present disclosure, when it is detected that the electronic device activates an eMBB service, the electronic device acquires a service identifier matching the current communication status of the electronic device is acquired, and displays the service identifier on the interface for the eMBB service of the electronic device. As can be seen, during the execution of the eMBB service, the electronic device can display a proper service identifier, such as a first service identifier or a second service identifier, according to the communication status. In this way, the actual communication status of the electronic device during the eMBB service can be accurately, intuitively and comprehensively displayed, which is beneficial to improve the comprehensiveness and accuracy of the information display of the electronic device under the eMBB service.

In addition, the electronic device can quickly and accurately determine the service identifier of the eMBB service by means of the query mechanism, improving the accuracy and efficiency of displaying the service identifier.

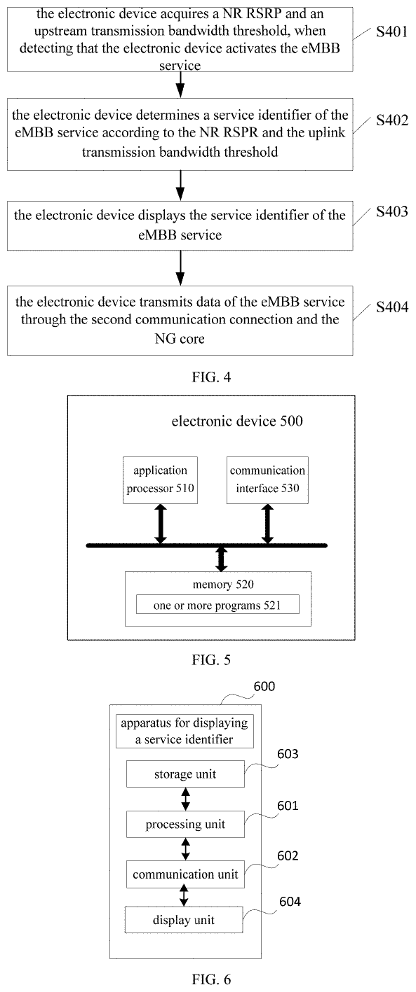

Referring to FIG. 4, a schematic flow chart of a method for displaying a service identifier according to the embodiments of the present disclosure is illustrated, which is consistent to the embodiment shown in FIG. 2. The method may be applied to an electronic device. The electronic device supports an eMBB service and a doubly connected mode. In the doubly connected mode, the electronic device establishes a first communication connection with a first network device and establishes a second communication connection with a second network device. The first and second network devices are on a first 5G NSA network. The first network device is an evolutional 4G nodeB (eNB), and the second network device is a 5G nodeB (gNB). A core of the first 5G NSA network is a NG core. The first network device communicates with the second network device and the NG core. As shown in the figure, the method for displaying a service identifier may include operations as follows.

In operation S401, the electronic device acquires a NR Reference Signal Receiving Power (RSRP) and an upstream transmission bandwidth threshold, when it is detected that the electronic device activates the eMBB service.

In operation S402, the electronic device determines a service identifier of the eMBB service according to the NR RSPR and the uplink transmission bandwidth threshold.

In operation S403, the electronic device displays the service identifier of the eMBB service.

In operation S404, the electronic device transmits data of the eMBB service through the second communication connection and the NG core.

In the embodiments of this disclosure, when it is detected that the electronic device activates an eMBB service, the electronic device acquires a NR RSRP and an upstream transmission bandwidth threshold, determines a service identifier of the eMBB service according to the NR RSPR and the upstream transmission bandwidth threshold, and displays the service identifier on an interface. As can be seen, during the execution of the eMBB service, the electronic device can determine the corresponding service identifier according to the status of the uplink data, and display for example a 4G identifier or a 5G identifier. In this way, the actual data transmission status of the electronic device during the eMBB service can be accurately, intuitively and comprehensively displayed, which is beneficial to improve the comprehensiveness and accuracy of the information display of the electronic device under the eMBB service.

In addition, since the electronic device is in the doubly connected mode, the transmission of the service data can be flexibly selected based on the quality of the channels, thereby improving the efficiency and stability of the data transmission.

Referring to FIG. 5, a schematic structural diagram of an electronic device 500 according to the embodiments of the present disclosure is illustrated, which is consistent to the embodiments shown in FIG. 2, FIG. 3 and FIG. 4. As shown in the figure, the electronic device 500 supports an eMBB service and a doubly connected mode. In the doubly connected mode, the electronic device 500 establishes a first communication connection with a first network device and establishes a second communication connection with a second network device. The first and second network devices are on a first 5G NSA network. The first network device is an evolutional 4G nodeB (eNB), and the second network device is a 5G nodeB (gNB). A core of the first 5G NSA network is a NG core. The first network device communicates with the second network device and the NG core. The electronic device 500 includes an application processor 510, a memory 520, and a communication interface 530, where one or more programs 521 are stored in the memory 520 and configured to be executed by the application processor 510. The one or more programs 521 include instructions which, when being executed by the application processor 510, cause the application processor 510 to implement the following operations: sending, to the 5G NG core, a service identifier query request for querying a service identifier of the eMBB service, when it is detected that the electronic device activates the eMBB service; receiving service identifier indication information returned from the 5G NG core; determining the service identifier of the eMBB service according to the service identifier indication information; and displaying the service identifier of the eMBB service.

In an implementation, the service identifier indication information includes a NR RSRP and an upstream transmission bandwidth threshold, and the determining the service identifier of the eMBB service according to the service identifier indication information includes: determining the service identifier of the eMBB service according to the NR RSPR and the uplink transmission bandwidth threshold.

In an implementation, the service identifier indication information indicates the service identifier of the eMBB service to be displayed, and the determining the service identifier of the eMBB service according to the service identifier indication information includes: extracting the service identifier of the eMBB service to be displayed from the service identifier indication information.

In an implementation, the instructions, when being executed by the application processor 510, may further cause the application processor 510 to implement the following operations: transmitting data of the eMBB service through the first 5G NSA network.

Regarding the details of determining the service identifier of the eMBB service according to the NR RSPR and the uplink transmission bandwidth threshold, the details of displaying the service identifier of the eMBB service, and the details of transmitting data of the eMBB service, reference may be made to the foregoing, which will not be repeated here.

In the embodiments of this disclosure, when it is detected that the electronic device activates an eMBB service, the electronic device acquires a NR RSRP and an upstream transmission bandwidth threshold, determines a service identifier of the eMBB service according to the NR RSPR and the upstream transmission bandwidth threshold, and display the service identifier on an interface. As can be seen, during the execution of the eMBB service, the electronic device can determine the corresponding service identifier according to the status of the uplink data, and display for example a 4G identifier or a 5G identifier. In this way, the actual data transmission status of the electronic device during the eMBB service can be accurately, intuitively and comprehensively displayed, which is beneficial to improve the comprehensiveness and accuracy of the information display of the electronic device under the eMBB service.

The introduction of the solutions of the embodiments of the present disclosure in the foregoing is mainly from the perspective of the execution of a method. It can be understood that, in order to implement the functions mentioned above, the electronic device may include corresponding hardware structure(s) and/or software module(s) to achieve the various functions. Those skilled in the art should easily realize that the units and algorithm operations of the various examples described in combination with the embodiments provided herein can be implemented in hardware or a combination of hardware and computer software. Whether a function is executed by hardware or by driving hardware with computer software may depend on the specific application and design constraints of the technical solution. Technicians may use different methods to implement the described functions for each specific application, but such implementation should not be considered as going beyond the scope of this disclosure.

In the embodiments of the present disclosure, the electronic device may be divided into functional units according to the foregoing examples of the method. For example, one functional unit may be divided for each function, or two or more functional units may be integrated into one processing unit. The integrated unit may be realized in hardware or software functional unit(s). It should be noted that the division of the units in the embodiments of the present disclosure is illustrative, which is made only in terms of logical function, and there may be other divisions in actual implementation.

FIG. 6 is a block diagram of the functional units of an apparatus for displaying a service identifier 600 according to the embodiments of the present disclosure. The apparatus for displaying a service identifier 600 may be applied to an electronic device, and the electronic device supports an eMBB service and a doubly connected mode. In the doubly connected mode, the electronic device establishes a first communication connection with a first network device and establishes a second communication connection with a second network device. The first and second network devices are on a first 5G NSA network. The first network device is an evolutional 4G nodeB (eNB), and the second network device is a 5G nodeB (gNB). A core of the first 5G NSA network is a NG core. The first network device communicates with the second network device and the NG core. The apparatus for displaying a service identifier 600 may include a processing unit 601, a communication unit 602, and a display unit 604.

The processing unit 601 is configured to acquire a NR RSRP and an upstream transmission bandwidth threshold when it is detected that the electronic device activates the eMBB service, determine a service identifier of the eMBB service according to the NR RSPR and the upstream transmission bandwidth threshold, and control the display unit to display the service identifier of the eMBB service.

The apparatus for displaying a service identifier 600 may further include a storage unit 603 for storing program codes and data of the electronic device. The processing unit 601 may be a processor, the communication unit 602 may be a touch screen or a transceiver, and the storage unit 603 may be a memory.

In the embodiments of this disclosure, when it is detected that the electronic device activates an eMBB service, the electronic device acquires a NR RSRP and an upstream transmission bandwidth threshold, determines a service identifier of the eMBB service according to the NR RSPR and the upstream transmission bandwidth threshold, and display the service identifier on an interface. As can be seen, during the execution of the eMBB service, the electronic device can determine the corresponding service identifier according to the status of the uplink data, and display for example a 4G identifier or a 5G identifier. In this way, the actual data transmission status of the electronic device during the eMBB service can be accurately, intuitively and comprehensively displayed, which is beneficial to improve the comprehensiveness and accuracy of the information display of the electronic device under the eMBB service.

The embodiments of the present disclosure further provide a non-transitory computer storage medium. The non-transitory computer storage medium stores a computer program for electronic data interchange. The computer program is operable to be executed by an electronic device, the electronic device supports an eMBB service, and communicates simultaneously with an evolutional 4G nodeB and a 5G nodeB. The 4G nodeB and the 5G nodeB are on a 5G NSA network having a 5G NG core. The 5G NG core, the 4G nodeB, and the 5G nodeB communicate with each other. The computer program, when being executed by a computer, causes the computer to execute part or all of the operations of any method as recited in the above method embodiments. The computer includes an electronic device.

Specifically, the computer program, when being executed by the electronic device, cause the electronic device to implement operations including: acquiring service identifier indication information for the eMBB service, when it is detected that the electronic device activates the eMBB service; determining a service identifier of the eMBB service according to the service identifier indication information; and displaying the service identifier of the eMBB service.

In an implementation, the service identifier indication information includes a NR RSRP and an upstream transmission bandwidth threshold, and the determining the service identifier of the eMBB service according to the service identifier indication information includes: determining the service identifier of the eMBB service according to the NR RSPR and the uplink transmission bandwidth threshold.

In an implementation, the service identifier indication information indicates the service identifier of the eMBB service to be displayed, and the determining the service identifier of the eMBB service according to the service identifier indication information includes: extracting the service identifier of the eMBB service to be displayed from the service identifier indication information.

In an implementation, the computer program, when being executed by the electronic device, may further cause the electronic device to transmit data of the eMBB service through the first 5G NSA network.

Regarding the details of determining the service identifier of the eMBB service according to the NR RSPR and the uplink transmission bandwidth threshold, the details of displaying the service identifier of the eMBB service, and the details of transmitting data of the eMBB service, reference may be made to the foregoing, which will not be repeated here.

The embodiments of the present disclosure further provide a computer program product. The computer program product includes a non-transitory computer-readable storage medium storing a computer program. The computer program is operable to cause a computer to execute part or all of the operations of any method as recited in the above method embodiments. The computer program product may be a software installation package, and the computer includes an electronic device.

It should be noted that, as for the foregoing method embodiments, they are all expressed as a combination of a series of action s for the sake of simple description, but those skilled in the art should know that this disclosure is not limited by the described sequence of the actions. That is because some operations can be performed in other order or simultaneously according to this disclosure. Secondly, those skilled in the art should also know that the embodiments described in the description are all preferred embodiments, and the involved actions and modules are not necessarily required by this disclosure.

In the above-mentioned embodiments, the description of each embodiment has its own focus. For parts that are not described in detail in an embodiment, reference may be made to related descriptions of other embodiments.

It should be understood that, in the several embodiments provided in this disclosure, the disclosed apparatus may be implemented in other ways. For example, the apparatus embodiments described above are merely illustrative. For example, the division of the above-mentioned units is only made in terms of logical function, and there may be other divisions in actual implementation. For example, multiple units or components may be combined or integrated into another system, or some features may be omitted or not implemented. In addition, the coupling, including direct coupling or communication connection, between the units shown or discussed may be indirect coupling or communication connection by means of some interfaces, devices or modules, which may be electrical, mechanical or in other forms.

The units described as separate components in the above may or may not be physically separated, and the components displayed as units may or may not be physical units, that is, they may be located in one place or may be distributed on multiple network units. Some or all of the units may be selected according to actual needs to achieve the objectives of the solutions of the embodiments.

In addition, the functional units in the embodiments of the disclosure may be integrated into one processing unit, or each of the units may exist alone physically, or two or more units may be integrated into one unit. The integrated unit may be implemented in hardware or software functional unit(s).

The integrated unit, when being realized in software functional units and sold or used as an independent product, can be stored in a computer readable memory. Based on this understanding, the essential technical solution of the present disclosure, or the part that contributes to the related art, or all or part of the technical solution can be embodied in a software product. The computer software product may be stored in a memory, and include several instructions that cause a computer device (which may be a personal computer, a server, a network device, or the like) to execute all or part of the operations of the foregoing methods of the various embodiments of the present disclosure. The memory may include: a U disk, a read-only memory (ROM), a random access memory (RAM), a mobile hard disk, a magnetic disk, an optical disk or other media that can store program codes.

Those of ordinary skill in the art can understand that all or part of the operations in the methods of the above embodiments can be completed by instructing relevant hardware with a program. The program may be stored in a computer-readable memory, and the memory may include: a flash disk, a read-only memory (ROM), a random access memory (RAM), a magnetic disk, an optical disk, or the like.

The embodiments of the disclosure have been described in detail in the foregoing, and specific examples are adopted herein to illustrate the principle and implementations of the disclosure. The descriptions of the above embodiments are only used to facilitate understanding of the method and core ideas of the present disclosure. In addition, it is clear for those skilled in the art that the specific implementations and the application ranges may change at some extent, based on the concepts of the present disclosure. In summary, the contents of this description should not be construed as limiting this disclosure.

What is claimed is:

1. A method for displaying a service identifier, applicable to an electronic device, wherein the electronic device supports an enhanced Mobile Broadband (eMBB) service and a doubly connected mode, the electronic device establishes a first communication connection with a first network device and establishes a second communication connection with a second network device in the doubly connected mode, the first and second network devices are on a first 5th Generation (5G) Non-Standalone (NSA) network, the first network device is an evolutional 4th Generation (4G) nodeB, the second network device is a 5G nodeB, a core of the first 5G NSA network is a 5G Next Generation (NG) core, the first network device communicates with the second network device and the 5G NG core, and the method comprises:
acquiring a New Radio (NR) Reference Signal Receiving Power (RSRP) and an uplink transmission bandwidth threshold, when it is detected that the electronic device activates the eMBB service;
determining a service identifier of the eMBB service according to the NR RSPR and the uplink transmission bandwidth threshold; and
displaying the service identifier of the eMBB service.

2. The method as claimed in claim 1, wherein the determining the service identifier of the eMBB service according to the NR RSPR and the uplink transmission bandwidth threshold, comprises:
determining a 5G identifier of the eMBB service as the service identifier of the eMBB service, when the NR RSPR is greater than a power threshold and the uplink transmission bandwidth threshold is greater than an uplink threshold; or
acquiring a 4G ratio LTE_ratio and a 5G ratio NR_ratio in an uplink data distribution when the NR RSPR is smaller than the power threshold and the uplink transmission bandwidth threshold is smaller than the uplink threshold, and determining a 4G identifier of the eMBB service as the service identifier of the eMBB service when the LTE_ratio is greater than the NR_ratio, or determining a 5G identifier of the eMBB service as the service identifier of the eMBB service when the LTE_ratio is smaller than or equal to the NR_ratio.

3. The method as claimed in claim 2, wherein the LTE_ratio is calculated as follows:
LTE_ratio=(10 GB-A)/10 GB, where A is an uplink transmission bandwidth pre-assigned to the first network device, and
wherein the NR_ratio is obtained by subtracting the LTE_ratio from the uplink transmission bandwidth threshold.

4. The method as claimed in claim 2, wherein the 5G identifier of the eMBB service is 5G eMBB, and the 4G identifier of the eMBB service is 4G.

5. The method as claimed in claim 1, wherein after it is detected that the electronic device activates the eMBB service, the method further comprises:
sending, to the first network device, a service identifier query request for querying the service identifier of the eMBB service; and
receiving service identifier indication information from the first network device, the service identifier indication information comprising the NR RSRP and the uplink transmission bandwidth threshold.

6. The method as claimed in claim 1, wherein the displaying the service identifier of the eMBB service, comprises:
displaying the service identifier at a preset position of an interface for the eMBB service of the electronic device, the preset position matching a display position of the electronic device where a network connection status is displayed.

7. The method as claimed in claim 1, wherein the method further comprises:
transmitting data of the eMBB service through the first 5G NSA network.

8. The method as claimed in claim 7, wherein the transmitting the data of the eMBB service through the first 5G NSA network, comprises:
transmitting the data of the eMBB service through the second communication connection and the 5G NG core.

9. The method as claimed in claim 7, wherein the transmitting the data of the eMBB service through the first 5G NSA network, comprises:
transmitting the data of the eMBB service through the second and first communication connections and the 5G NG core.

10. An electronic device, comprising a processor, a memory, and a communication interface, the memory storing one or more programs, wherein the electronic device supports an enhanced Mobile Broadband (eMBB) service, and communicates simultaneously with an evolutional 4th Generation (4G) nodeB and a 5th Generation (5G) nodeB, the 4G nodeB and the 5G nodeB are on a 5G Non-Standalone (NSA) network having a 5G Next Generation (NG) core, the 5G NG core, the 4G nodeB, and the 5G nodeB communicate with each other, and the one or more programs including instructions which, when being executed by the processor, cause the processor to implement operations comprising:
sending, to the 5G NG core, a service identifier query request for querying a service identifier of the eMBB service, when it is detected that the electronic device activates the eMBB service;
receiving service identifier indication information returned from the 5G NG core;
determining the service identifier of the eMBB service according to the service identifier indication information; and
displaying the service identifier of the eMBB service.

11. The electronic device as claimed in claim 10, wherein the service identifier indication information comprises a New Radio (NR) Reference Signal Receiving Power (RSRP) and an uplink transmission bandwidth threshold, and the determining the service identifier of the eMBB service according to the service identifier indication information comprises:
determining the service identifier of the eMBB service according to the NR RSRP and the uplink transmission bandwidth threshold.

12. The electronic device as claimed in claim 11, wherein the determining the service identifier of the eMBB service according to the NR RSRP and the uplink transmission bandwidth threshold, comprises:
determining a 5G identifier of the eMBB service as the service identifier of the eMBB service, when the NR RSPR is greater than a power threshold and the uplink transmission bandwidth threshold is greater than an uplink threshold; or
acquiring a 4G ratio LTE_ratio and a 5G ratio NR_ratio in an uplink data distribution when the NR RSPR is smaller than the power threshold and the uplink transmission bandwidth threshold is smaller than the uplink threshold, and determining a 4G identifier of the eMBB service as the service identifier of the eMBB service when the LTE_ratio is greater than the NR_ratio, or determining a 5G identifier of the eMBB service as the service identifier of the eMBB service when the LTE_ratio is smaller than or equal to the NR_ratio.

13. The electronic device as claimed in claim 12, wherein the LTE_ratio is calculated as follows:
LTE_ratio=(10 GB-A)/10 GB, where A is an uplink transmission bandwidth pre-assigned to the 4G nodeB, and
wherein the NR_ratio is obtained by subtracting the LTE_ratio from the uplink transmission bandwidth threshold.

14. The electronic device as claimed in claim 10, wherein the service identifier indication information indicates the service identifier of the eMBB service to be displayed, and the determining the service identifier of the eMBB service according to the service identifier indication information comprises:
extracting the service identifier of the eMBB service to be displayed from the service identifier indication information.

15. The electronic device as claimed in claim 10, wherein the displaying the service identifier of the eMBB service, comprises:
displaying the service identifier at a preset position of an interface for the eMBB service of the electronic device, the preset position matching a display position of the electronic device where a network connection status is displayed.

16. A non-transitory computer-readable storage medium, storing a computer program thereon, wherein the computer program is operable to be executed by an electronic device, the electronic device supports an enhanced Mobile Broadband (eMBB) service, and communicates simultaneously with an evolutional 4th Generation (4G) nodeB and a 5th Generation (5G) nodeB, the 4G nodeB and the 5G nodeB are on a 5G Non-Standalone (NSA) network having a 5G Next Generation (NG) core, the 5G NG core, the 4G nodeB, and the 5G nodeB communicate with each other, and the computer program, when being executed by the electronic device, cause the electronic device to implement operations including:
acquiring service identifier indication information for the eMBB service, when it is detected that the electronic device activates the eMBB service;
determining a service identifier of the eMBB service according to the service identifier indication information; and
displaying the service identifier of the eMBB service.

17. The non-transitory computer-readable storage medium as claimed in claim 16, wherein the service identifier indication information comprises a New Radio (NR) Reference Signal Receiving Power (RSRP) and an uplink transmission bandwidth threshold, and the determining the service identifier of the eMBB service according to the service identifier indication information comprises:
determining a 5G identifier of the eMBB service as the service identifier of the eMBB service, when the NR RSPR is greater than a power threshold and the uplink transmission bandwidth threshold is greater than an uplink threshold; or
acquiring a 4G ratio LTE_ratio and a 5G ratio NR_ratio in an uplink data distribution when the NR RSPR is smaller than the power threshold and the uplink transmission bandwidth threshold is smaller than the uplink threshold, and determining a 4G identifier of the eMBB service as the service identifier of the eMBB service when the LTE_ratio is greater than the NR_ratio, or determining a 5G identifier of the eMBB service as the service identifier of the eMBB service when the LTE_ratio is smaller than or equal to the NR_ratio.

18. The non-transitory computer-readable storage medium as claimed in claim 17, wherein the LTE_ratio is calculated as follows:
LTE_ratio=(10 GB-A)/10 GB, where A is an uplink transmission bandwidth pre-assigned to the 4G nodeB, and
wherein the NR_ratio is obtained by subtracting the LTE_ratio from the uplink transmission bandwidth threshold.

19. The non-transitory computer-readable storage medium as claimed in claim 16, wherein the service identifier indication information indicates the service identifier of the eMBB service to be displayed, and the determining the service identifier of the eMBB service according to the service identifier indication information comprises:
extracting the service identifier of the eMBB service to be displayed from the service identifier indication information.

20. The non-transitory computer-readable storage medium as claimed in claim 16, wherein the displaying the service identifier of the eMBB service, comprises:
displaying the service identifier at a preset position of an interface for the eMBB service of the electronic device, the preset position matching a display position of the electronic device where a network connection status is displayed.
